(19) United States
(12) Patent Application Publication
(10) Pub. No.: US 2005/0014502 A1
(43) Pub. Date: Jan. 20, 2005

(54) Information disclosure system using cellular phone

(75) Inventor: Hiroji Akahori, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/847,908

(22) Filed: May 19, 2004

(30) Foreign Application Priority Data
Jul. 18, 2003 (JP) 2003-276991

(51) Int. Cl. H04Q 7/20

(52) U.S. Cl. 455/435.1; 455/456.5; 455/411

(57) ABSTRACT

The present invention provides an easy method of disclosing personal information with an indefinite number of people lying in a specific area as targets. When a cellular phone is used to disclose its personal information, one of base stations or a base station group comprising a plurality of the base stations is designated to register information to be opened, and the information is made openable to only a user of the cellular phone communicable with the corresponding base station. When, at this time, the person that has registered the information is moved beyond a communicable range of the base station or the base station group, the disclosure of the registered information can also be prohibited or deleted.

### BACKGROUND OF THE INVENTION

1. Field of the Invention

The present invention relates to a system which uses cellular phones and which discloses personal information of a cellular phone user to a communication service area of a base station communicating with the cellular phone and offers information to other cellular phone user existing in the same service area or other cellular phone user existing in a service area of a specified base station.

2. Description of the Related Art

As a method of disclosing electronic personal information, which has heretofore been carried out through Internet or the like, there is known a notice-board system or the like, for example. The present disclosing method was a system wherein no limitation was imposed on an open area and information was disclosed to an indefinite number of persons. When users are limited in such an information disclosing system, the limiting side issued a password to a normal user and the corresponding user was identified by the input of the password.

There has heretofore been known a service for transmitting community information of an area to which a mobile hand-held terminal belongs, to a hand-held terminal such as a cellular phone via a base station lying in the area.

However, the conventional information disclosure system did not have means for disclosing personal information by a simple method with an indefinite number of people lying in a specific area as targets.

### SUMMARY OF THE INVENTION

With the foregoing in view, the present invention therefore provides an information disclosure system using cellular phones, comprising base stations or a base station group configured of a plurality of the base stations, wherein when one of the cellular phones is used to disclose its personal information, the base station or the base station group is designated to register information to be opened, and the personal information is made openable to only a user of the cellular phone communicable with the corresponding base station. Thus, information can be disclosed with an indefinite number of persons lying in a specific area as targets.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a conceptual diagram showing a specific example 1 of an information disclosure system using cellular phones;

FIG. 2 is a conceptual diagram illustrating a specific example 2 of an information disclosure system using cellular phones;

FIG. 3 is a conceptual diagram depicting a specific example 3 of an information disclosure system using cellular phones;

FIG. 4 is a conceptual diagram showing a specific example 4 of an information disclosure system using cellular phones;

FIG. 5 is a conceptual diagram illustrating a specific example 5 of an information disclosure system using cellular phones; and

FIG. 6 is a conceptual diagram showing a specific example 6 of an information disclosure system using cellular phones.

### DETAILED DESCRIPTION OF THE INVENTION

Each of information disclosure systems according to the present invention is based on the premise that the information disclosing side and the information inspecting or accessing side are located in positions close to each other in advance. The information disclosure system does not disclose information at a remote place. In the information disclosure system according to the present invention, an information-disclosed area is limited to a specified or designated area. Therefore, the information disclosure system intends to disclose personal information to an indefinite number of users only within a desired narrow area. The information disclosure system according to the present invention is based on the premise that each of personal information terminals such as a cellular phone, a device attached to a cellular phone, etc. holds the function of being capable of inspecting or accessing electronic information (unlimited to personal information in particular) of another user b from a cellular phone of a user a.

### SPECIFIC EXAMPLE 1

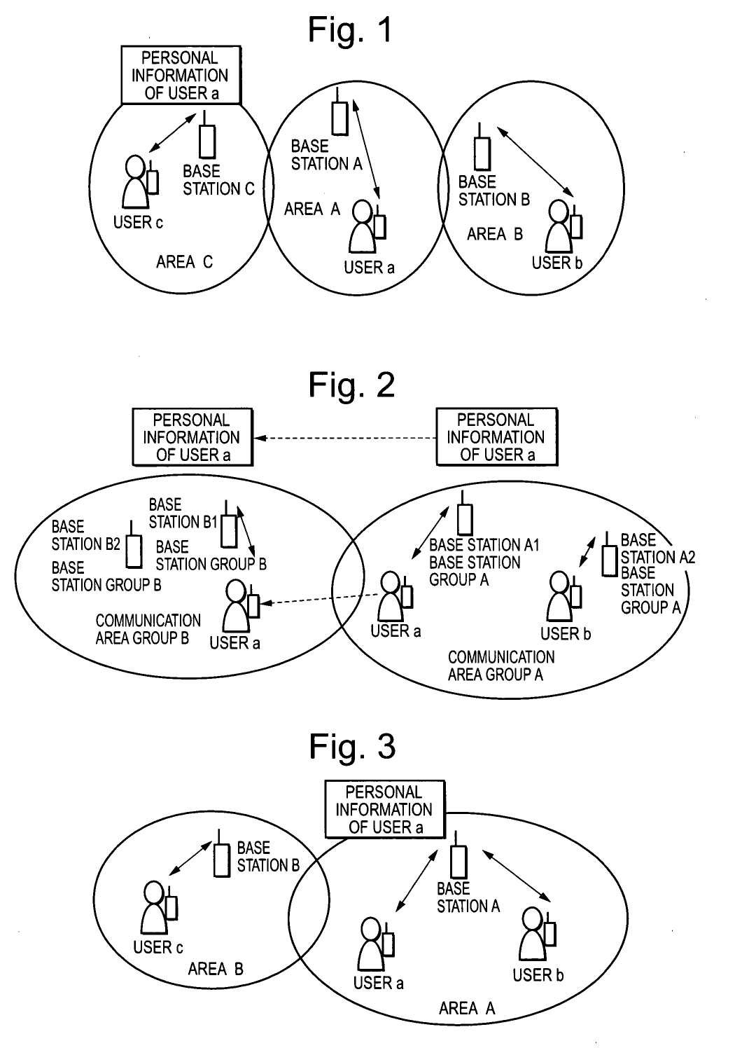

FIG. 1 is a conceptual diagram showing a specific example 1 of an information disclosure system according to the present invention.

When a user a desires to disclose his/her personal information at a specific area A, the user a creates open information and thereafter transmits it to a base station A lying within the corresponding area. Upon registration of the personal information of the user a, the name of a base station lying in each open area or the name of a base station group (hereinafter called “base station select information”) comprising a plurality of base stations is specified together with the personal information. The personal information is stored in a base station device suited to the base station select information, a cellular phone communication network, and other communication network connected to the cellular phone communication network.

Now consider that the user a designates his/her own personal information such that it is open to only a communication area B of a base station B. The user b whose line is ensured by the base station B, obtains access to an information storage location in an attempt to inspect or access the personal information registered by other user. When that information that the user a has communicated with the base station B, is contained in the connection information of the user b, the base station B is included in the base station select information of the personal information of the user a. Therefore, the user b is capable of inspecting the personal information of the user a.

On the other hand, when a user c whose line is ensured by a base station C intends to inspect the personal information of the user a, the user c is capable of inspecting it only when the base station C is contained in the base station select information. Therefore, if the base station C is not included in the base station select information in this case, then the user c is not able to obtain access to the personal information of the user a.

When the user a is shifted from the communication area A of the base station A with which the personal information thereof has been registered, or the user a falls into a state of being unable to communicate due to the turning off of a power supply of the cellular phone thereof, or the like, the prohibition of the inspection or accessing of the registered personal information or the erasure of the registered information can also be carried out.

By adding time factors such as an open time, an open schedule or date, an open period, etc. to personal information to be disclosed, the time required to disclose information from the designated base station can be specified, and the open date and period can also be limited.

As described above, the user a is able to disclose the personal information to an indefinite number of users under an arbitrary area limitation.

### SPECIFIC 2

FIG. 2 is a conceptual diagram showing a specific example 2 of an information disclosure system according to the present invention. In the present specific example, a plurality of base stations constitute a base station group.

Now consider that when a user a registers his/her own personal information, the user a designates the personal information so that the personal information is disclosed to a base station group communicating with the user a, and the user a designates the personal information so as to cause the corresponding base station group to shift the personal information with the movement of the user a.

When a cellular phone of the user a is moved and the user a is moved from a communication area group A placed under a pre-designated base station group A to a communication area group B placed under other base station group B, the corresponding base station that discloses personal information is changed from the base station group A to the base station group B.

Thus, if the communicated and complemented base station of the user b is not contained in the base station group B to which the user a is shifted, then the user b placed in the communication area group A is not able to inspect or access the personal information of the user a when the user a is moved to the base station group B.

Since the destination to register the registered personal information of the user a is changed to the corresponding base station group that complements the cellular phone of the user a and is in communication therewith even if the base station communicating with the cellular phone of the user a is changed, such a mechanism makes it possible to occasionally follow a personal information inspecting area of the user a with its movement.

Since the user b is capable of obtaining permission so as to be able to inspect the personal information of the user a at other area in addition to the above, the user b is also able to inspect or access the personal information of the user a even at other than an area specified by a specific user alone.

### SPECIFIC EXAMPLE 3

FIG. 3 is a conceptual diagram showing a specific example 3 of an information disclosure system according to the present invention.

In the present specific example, when a user a desires to disclose his/her personal information, the user a creates open information and thereafter transmits it to a base station A. The personal information of the user a includes a history in which the user a has communicated with the base station A, and is held in a base station device, a cellular phone communication network, and other communication network connected to the cellular phone communication network.

The user b whose line is ensured by the base station A, obtains access to an information stored location with a view toward inspecting or accessing information registered by other user (e.g., user a). When the information that the user a has communicated with the base station A, is contained in the connection information of the user b at this time, the user b is able to inspect only the personal information (e.g., personal information of user a) to which the history of communication with the base station A is given. Thus, the user b is capable of inspecting the personal information of the user a.

When a user c placed within an area B, whose line is ensured by a base station B, attempts to inspect personal information, only information to which the history of the base station B is given, can be inspected. Therefore, the user c is not able to inspect the personal information of the user a.

When the user a gets free of a communication area A of the base station A with which the personal information thereof has been registered, or the user a falls into a communication disabled state such as turning off of a power supply of a cellular phone thereof, the prohibition of the inspection or accessing of the registered personal information or the erasure of the registered information can be set in advance such that they are carried out. Thus, the user a is able to disclose the personal information under a communication area-in limitation of an arbitrary base station only during a period in which the cellular phone of the user a is being recognized by the arbitrary base station.

### SPECIFIC EXAMPLE 4

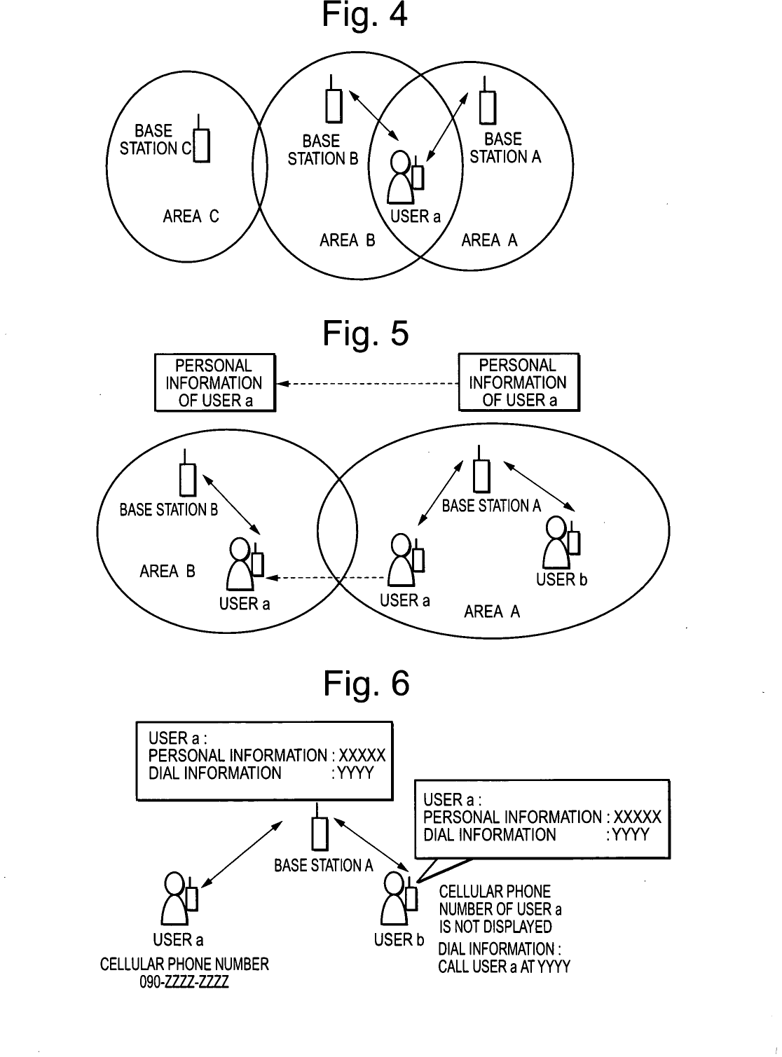

FIG. 4 is a conceptual diagram showing a specific example 4 of an information disclosure system according to the present invention.

In the specific example 3, base stations that disclose personal information are limited to base stations that has communicated upon personal information registration. In the present specific example, the personal information is disclosed only within communicable areas of a communicable base station (e.g., a base station A) recognized by a cellular phone of a user a and a base station (e.g., a base station B) adjacent to it, to which it is notified by the communicable base station, upon registration of personal information.

When the user a is shifted from the corresponding communication area upon registration of his/her personal information, the disclosure of the personal information at a base station communicable with the cellular phone of the user a or a base station adjacent to it, and a base station unrecognized by the cellular phone thereof is prohibited, or information about the personal information at those base stations is deleted. Thus, the user a is able to disclose the personal information by only the base stations around the user a.

### SPECIFIC EXAMPLE 5

FIG. 5 is a conceptual diagram showing a specific example 5 of an information disclosure system according to the present invention.

Now consider that in the present specific example, a user a has disclosed his/her personal information within a communication area A. When the corresponding line is ensured between the user a and a base station B where the user a is moved from the communication area A to an area B, a base-station history of the personal information registered in the communication area A is changed from A to B, and hence an information disclosure area is shifted in a manner similar to the moved position of the user.

When the cellular phone of the user a is complemented by the same base station B, a user b is able to inspect the personal information of the user a.

Thus, even if the callable area of the cellular phone of the user a is changed, the registered personal information of the user a is transferred to the corresponding base station that has complemented the cellular phone of the user a and is in communication therewith, whereby it allows the user a to always follow an area that discloses information with the movement of the user a.

### SPECIFIC EXAMPLE 6

FIG. 6 is a conceptual diagram showing a specific example 6 of an information disclosure system according to the present invention.

In the present specific example, when a user a expects incoming calls from an indefinite number of other parties upon disclosure of his/her personal information, dial information of the user a is added to the personal information of the user a. As the dial information, there are one that directly indicates a telephone number of a cellular phone and one that no indicates the telephone number.

When the dial information directly represents the cellular telephone number of the user a, a user b is able to make a phone call to the user a by a selective operation or a normal dial operation. On the other hand, when the dial information does not indicate the cellular phone number of the user a, the user b is able to communicate with the user a by the selective operation or dial operation of dial information different from the telephone number or the like peculiar to the cellular phone.

At this time, it is also feasible to cause the cellular phone of the user b corresponding to an outgoing origin so as not to notify or represent cellular phone information such as the cellular phone number of the user a. The information can be selected according to the will of the user a.

Also the dial information can be set as temporary and can be deleted easily if necessary.

With the operation of a management/operating dealer (hereinafter called “enterpriser”) of a cellular phone network, the cellular phone information such as these cellular phone numbers, etc. can be forcedly notified or displayed. The cellular phone information can also be un-notified or un-displayed in reverse.

As dial information directly non-indicative of cellular phone numbers, there are one numbered at random for each registration of personal information and one related to a user or a cellular phone. However, the enterpriser is cable of suitably determining the dial information.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

1. An information disclosure system using cellular phones, comprising:
base stations or a base station group comprising a plurality of the base stations,
wherein when one of the cellular phones is used to disclose its personal information, the base station or the base station group is designated to register information to be opened, and the personal information is made openable to only a user of the cellular phone communicable with the corresponding base station.

2. An information disclosure system according to claim 1, wherein when the user that has registered the information is moved beyond a communicable range of the base station or the base station group, the disclosure of the registered information is prohibited or deleted.

3. An information disclosure system according to claim 1, wherein the registered information is opened inclusive of time factors such as a time zone, date, a period to be opened.

4. An information disclosure system using cellular phones, which causes each of the cellular phones to have the function of causing base station select information of personal information to follow the movement of the cellular phone and which makes it possible to update the base station select information to base station select information including a base station communicating with the cellular phone as occasion arises.

5. An information disclosure system according to claim 4, wherein only a user allowed to make inspection is able to perform inspection even when the user is able to communicate only with a base station not included in the base station select information.

6. An information disclosure system using cellular phones, wherein one of the cellular phones registers its personal information in a communicable base station, and the personal information registered only in other cellular phone communicating with the base station is made open.

7. An information disclosure system according to claim 6, wherein when the cellular phone having registered the personal information is moved to a communicable area of the base station registered with the information and is brought to a communication disabled state, the disclosure of the registered personal information is prohibited or deleted.

8. An information disclosure system using cellular phones, wherein when one of the cellular phones is sued to register its personal information, information is added in such a manner that a communicable base station recognized by the cellular phone or a base station adjacent to the base station allows the personal information to be inspected, and the corresponding base station communicable with the cellular phone having registered the information or its adjacent base station discloses the personal information.

9. An information disclosure system using cellular phones, wherein when one of the cellular phones, which has registered its personal information, is moved along a communication area and a base station having disclosed information is not recognized as a base station communicable with the cellular phone having registered the information or its adjacent base station, the corresponding base station prohibits the disclosure of the personal information.

10. An information disclosure system using cellular phones, wherein when one of the cellular phones, which has registered its personal information, is moved and a communicable area is shifted, the registered personal information is shifted to a communicable base station in a communication area corresponding to a moving destination, thereby making it possible to automatically change an information-disclosing base station.

11. An information disclosure system using cellular phones, wherein when one of the cellular phones is used to register its personal information added with a telephone number in a base station, the telephone number is substituted with other information in such a manner that an incoming call from other cellular phone is received without the telephone number being recognized by other cellular phone, and the other information is open to public, and other cellular phone is capable of dialing to the cellular phone having registered the personal information, using the other information.

12. An information disclosure system according to claim 11, wherein the other information is dial information, and the dial information is temporary and capable of being deleted as needed and being added with new dial information.
